(19) United States
(12) Patent Application Publication
(10) Pub. No.: US 2006/0214449 A1
(43) Pub. Date: Sep. 28, 2006

(54) Vehicle bed extender internally mounted

(76) Inventor: Conrad P. Klusmeier, Scott City, MO (US)

Correspondence Address: CHARLES C. MCCLOSKEY, 763 S. NEW BALLAS ROAD STE. 170, ST. LOUIS, MO, 63141, US

(21) Appl. No.: 11/087,782

(22) Filed: Mar. 23, 2005

(51) Int. Cl. B62C 1/06

(52) U.S. Cl. 296/26.11

(57) ABSTRACT

The vehicle bed extender internally mounted modifies the open flat tailgate of a pickup truck or other vehicle, effectively lengthening the bed of the vehicle or truck. Three pieces of plate steel pivot upon hinges from within a tailgate to a vertical orientation. When upright, two sides or pieces pivot outwards and flank the main piece. The sides secure to the edge of the tailgate with clasps. With the extender open and secured, a truck bed carries more or lengthier cargo. After use, the sides swing beneath the panel and the panel folds into the interior of the tailgate. Alternatively, the extender attaches directly upon the inside surface of the tailgate.

### BACKGROUND OF THE INVENTION

The vehicle bed extender internally mounted relates generally to automotive accessories, and more specifically to cargo bed extensions.

Though short bed and flare side pickups remain popular, lumber such as plywood and studs still comes in eight foot lengths. When hauling lumber, drivers usually place a few pieces of lumber in the bed with the tailgate closed. The lumber often sticks out of the bed raising the risk of lumber exiting the bed into traffic. For larger loads, drivers open the tailgate and permit the lumber to lie upon the tailgate and extend rearward, often outside, of the pickup. Drivers usually mark the end of the lumber with a flag. For bulky, or granular, cargo, drivers leave the tailgate closed which limits hauling capacity to the volume of the bed alone. When a driver leaves the tailgate open, bulky cargo, such as gravel, can exit the bed and present a safety hazard to other traffic.

### DESCRIPTION OF THE PRIOR ART

Bed liners have proliferated in pickups across the nation. Following liners, drivers use bed extenders as an improvement to pickups. Existing extenders use single piece tubular steel frames that rest upon the tailgate of the pickup. A driver opens the tailgate, laying it flat. Then the driver expands the frame upon the tailgate to contain cargo. When not used, the driver collapses the frame upon the surface of the tailgate and the frame consumes space within the bed.

### SUMMARY OF THE INVENTION

Generally, the present invention provides three pieces upon hinges that allow drivers of pickup trucks to extend the bed of the pickup. Using a longer bed, pickups haul more cargo or longer cargo. The present invention lessens the space consumed by currently available bed extenders. Hinged pieces located within the tailgate take no cargo space from the pickup bed. The pickup retains the original hauling capacity of its bed with the present invention stowed. The present invention remains available for use when necessary to carry bulky or lengthy cargo.

There has thus been outlined, rather broadly, the more important features of the invention in order that the detailed description thereof that follows may be better understood and that the present contribution to the art may be better appreciated.

The invention may also include attaching the present invention directly upon the original manufacturer's interior panel of a tailgate. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved vehicle bed extender internally mounted.

Another object is to provide a vehicle bed extender internally mounted that can be easily and efficiently manufactured and marketed to the consuming public.

Another object is to provide a vehicle bed extender internally mounted that allows a driver to contain lengthy and bulky cargo within a pickup truck bed safely.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

FIG. 1 shows an isometric view of the present invention in the stowed position inside a tailgate of a pickup;

FIG. 2 shows another isometric view of the present invention raised upright and unfolding upon an open tailgate;

FIG. 3 describes another isometric view of the present invention fully deployed upon the tailgate.

FIG. 4A portrays a side view of the present invention and the securing means when in the stowed position within a tailgate;

FIG. 4B portrays a side view of the present invention and the securing means when unfolded and fully deployed;

FIG. 5 illustrates the present invention rotated beneath the tailgate;

FIG. 5A shows an alternate embodiment for temporarily securing the left piece and the right piece to the main piece; and,

FIG. 6 represents an alternate embodiment of the present invention attached to the interior of an existing tailgate.

The same reference numerals refer to the same parts throughout the various figures.

### DESCRIPTION OF THE PREFERRED EMBODIMENT

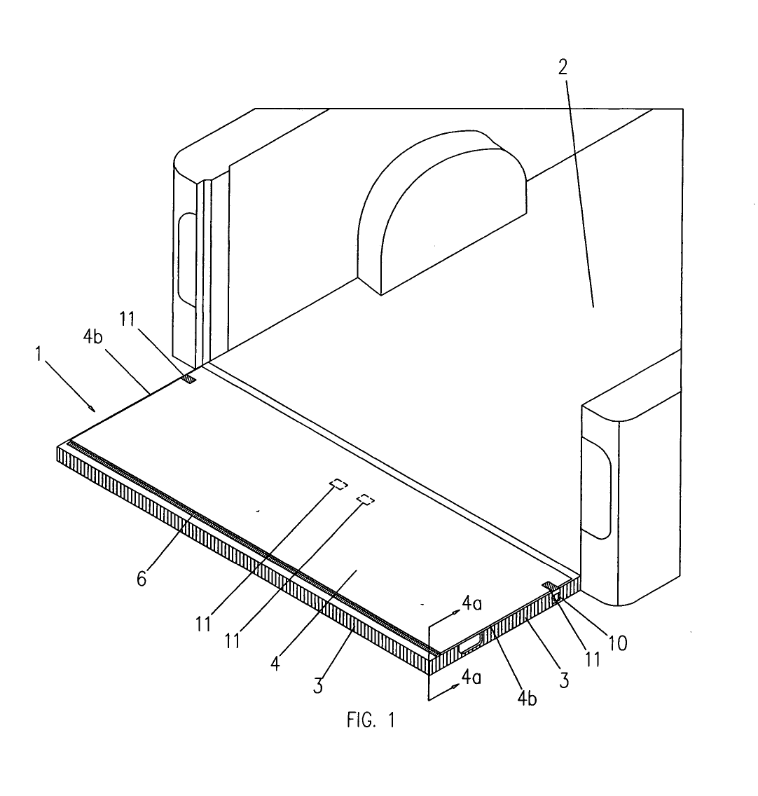

The present art overcomes the prior art limitations by providing a vehicle bed extender internally mounted that attaches to the interior of a tailgate of a pickup truck for ready use. Pickup trucks have short beds or flare sides as desired by drivers. However, pickup trucks often carry lengthy and bulky cargo that may extend beyond a short bed. The present invention 1 modifies an existing tailgate so that the bed 2 of a pickup can temporarily extend a length approximately that of the height of the bed 2. For pickup trucks, the present invention 1 has three pieces that store compactly in the interior of a tailgate 3 yet when opened, the pieces extend the bed 2. A fourth piece or liner 12 installs beneath the other three pieces. FIG. 1 shows the present invention 1 when stored. The present invention 1 has a main piece 4, generally steel and rectangular in shape with a length slightly less than the width of the tailgate 3. The main piece 4 has a width slightly less than the height of the tailgate 3. Generally rectangular, the main piece 4 has two mutually parallel and spaced apart longitudinal sides 4a and two mutually parallel and space apart lateral sides 4b perpendicular to the longitudinal edges 4a. One longitudinal edge 4a, opposite the bed 2, joins to the tailgate 3 with one or more first hinges 6. In the preferred embodiment, the first hinge 6 is a piano type hinge applied to the length of the main piece 4. The first hinge 6 attaches near the edge of the tailgate opposite the bed 2 and rotates 270° during use. In the preferred embodiment, the tailgate 3 is modified with a panel removed so the main piece 4 rests flush within the tailgate 3. In addition to the first hinge 6, the main piece 4 has the securing means 5 as one or more clasps 11 upon the lateral edges 4b generally opposite the first hinge 6 towards the bed 2. The clasps 11 cooperate with fittings collocated upon the sides of the tailgate 3. In the preferred embodiment, the fittings have a rotating bail 10 that grasps the clasps 11. The clasps 11 secure the main piece 4 in a closed position flush with the tailgate 3 in the preferred embodiment. The tailgate 3 has a typical hinged connection to the bed 2. The present invention 1 when folded as shown in FIG. 1 attains the stowed position.

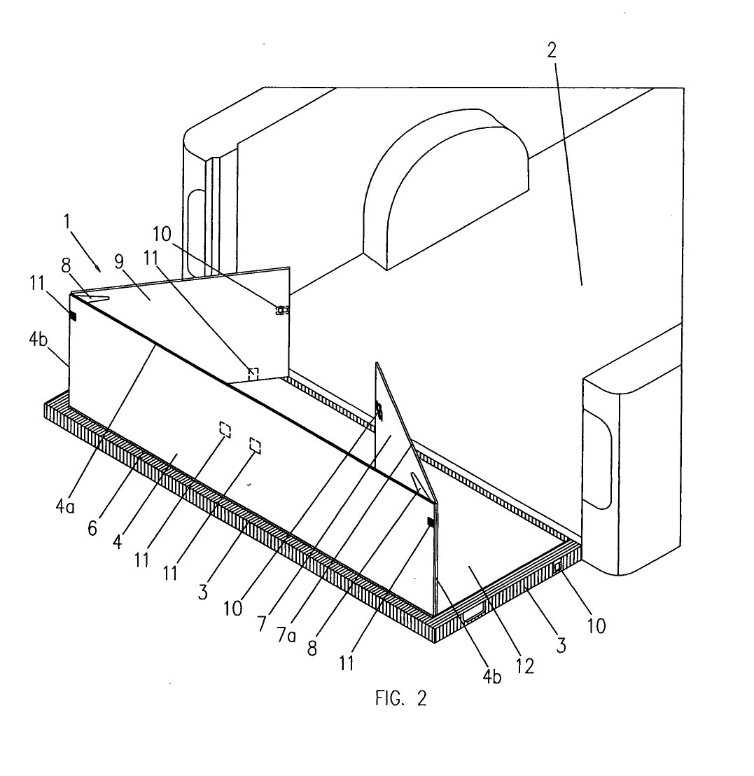

FIG. 2 shows the present invention 1 partially unfolded. Along with the main piece 4, the present invention 1 has a right piece 7 and a left piece 9 symmetrically arranged above a liner 12. The right piece 7 and the left piece 9 connect to the lateral edges 4b of the main piece 4. The right piece 7 and the left piece 9 are generally rectangular steel panels with a width the same as the main piece 4 and a length that spans the height of the tailgate 3 and partially into the bed 2. The length permits the left piece 9 and the right piece 7 to fold beneath the main piece 4 without interfering with each other. The left piece 9 and the right piece 7 each have mutually parallel and spaced apart longitudinal edges 9a, 7a and mutually parallel and spaced apart lateral edges 9b, 7b respectively perpendicular to the longitudinal edges. In the preferred embodiment, the right piece 7 and the left piece 9 each have two second hinges 8 that pivot upon the lateral edges 4a of the main piece 4 and the second hinges 8 are located upon the main piece 4, the left piece 9, and the right piece 7 upon the inside of the present invention 1 when unfolded. The left piece 9 and the right piece 7 each have a means to secure 5 the respective pieces to the tailgate 3 and to the main piece 4. In the preferred embodiment, the securing means 5 is clasps 11 centered and symmetric upon the inside face of the main piece 4 [shown in phantom] engage the fittings 10 upon the inside face of the left piece 9 and the right piece 7 when raising the presenting invention 1, and clasps 11 that also engage the fittings 10 upon the sides of the tailgate 3 when deploying the presenting invention 1.

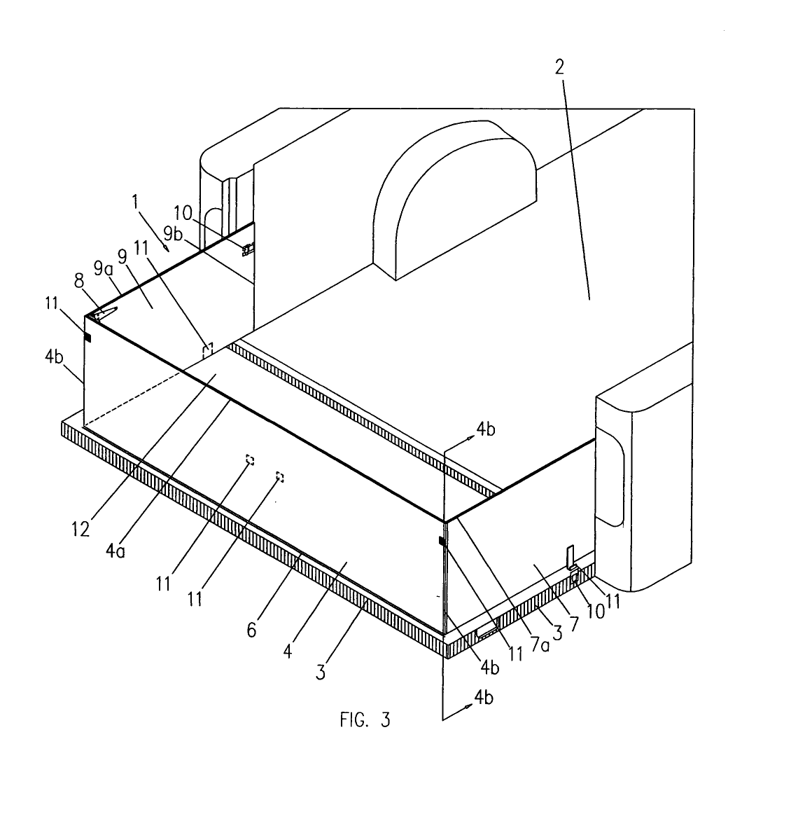

Turning to FIG. 3, the present invention 1 appears open in the deployed position and ready to carry cargo. The main piece 4 is unfolded upright upon the first hinge 6 so the lateral edges 4a are perpendicular to the open and flat tailgate 3. The left piece 9 and the right piece 7 are unfolded so the pieces 7, 9 are generally parallel to the length of the bed 2 and the sides of the tailgate 3. The securing means 5 then temporarily fixes the left piece 9 and the right piece 7 as open by cooperating with the fittings 10 upon the sides of the tailgate 3. The preferred clasps 11 engage the fittings 10 on the respective sides of the tailgate 3. Beneath the left piece 9, the right piece 7, and the main piece 4, a liner 12 generally rectangular in shape seals the interior of the tailgate. The liner 12 protects the original locking mechanism from damage by cargo and from accumulation of debris.

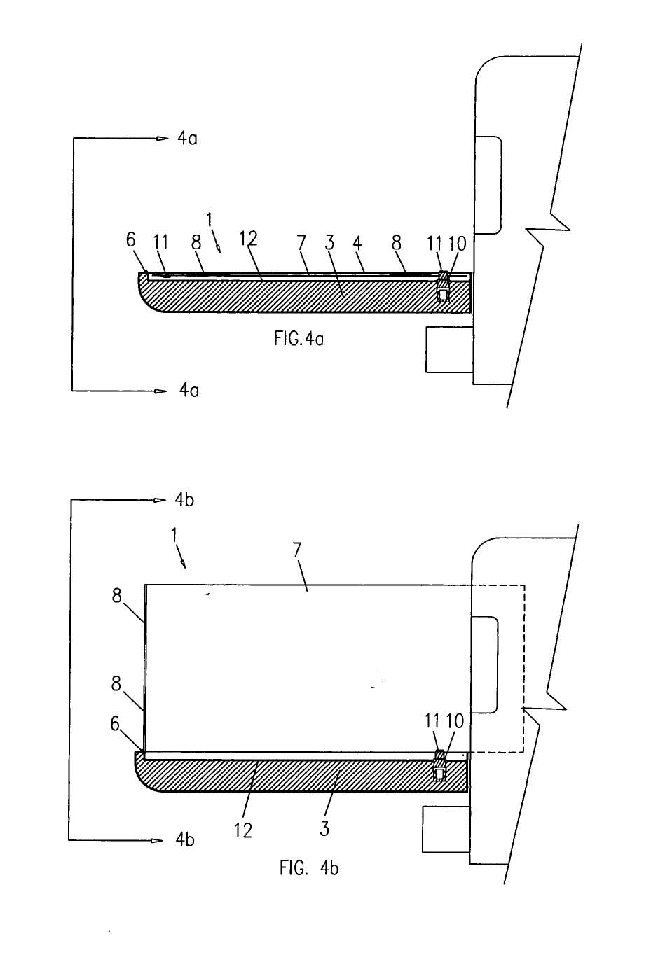

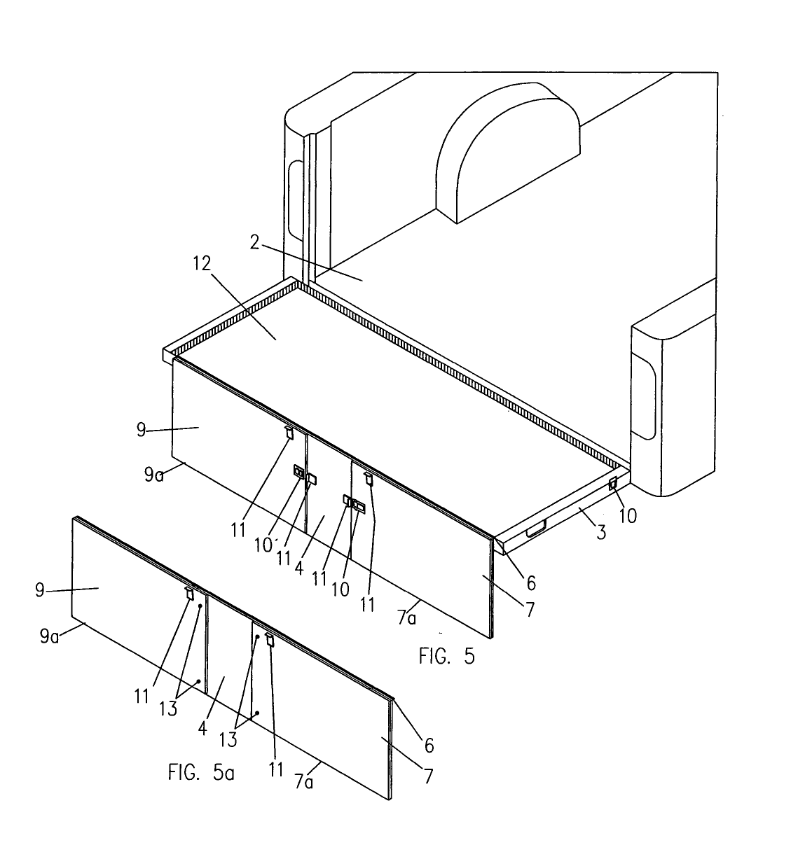

Showing the securing means 5 more closely, FIG. 4A has a sectional view of the device 1 when in the stowed position. The securing means 5 has a fitting 10 attached to the side of the tailgate 3, here shown as a pivoting bail 10 and, a fitting 10 attached to the right piece 7 to secure the right piece 7 to the main piece 4. First, the bail 10 upon the tailgate 3 envelopes the clasp 11 of the main piece 4 when the device 1 is stowed upon the tailgate 3. Second, as later shown in FIG. 5, upon the interior of the main piece 4, a symmetric pair of clasps 11 secure to fittings 10 upon each piece, here shown upon the right piece 7, generally centered upon the edge of the sectional view. When the device 1 is deployed as in FIG. 4B, the bail 10 envelopes a clasp 11 at the bottom corner towards the vehicle bed 2 upon the right piece 7 or left piece 9 respectively. The bails 10 and clasps 1 temporarily secure the main piece 4, the left piece 9, and the right piece 7 in either a stowed or deployed position at the discretion of the driver.

FIG. 5 shows the present invention 1 rotated down behind the tailgate 3 making the bed 2 ready to receive lengthy cargo. The first hinge 6 provides the main piece 4 the ability to rotate from a stowed position within the tailgate 3, to upright, and then to a down position. In the down position, the left piece 9 and the right piece 7 remain secured to the main piece 4 by clasps 11 centered and symmetric upon the main piece 4 and cooperating fittings 10 upon the left piece 9 and the right piece 7 respectively. After loading lengthy cargo, the left piece 9 and the right piece 7 are released from the main piece 4 to unfold. The driver then rotates the main piece 4 towards the lengthy cargo and, then secures the left piece 9 and the right piece 7 to the tailgate 3 at the fittings 10 near the hinge of the tailgate 3.

FIG. 5A provides an alternate embodiment of the securing means 5 to keep the left piece 9 and the right piece 7 upon the main piece 4 for the stowed position and when loading lengthy cargo. In the alternate embodiment, the left piece 9 and the right piece 7 each have two or more magnets 13 symmetrically arranged near the edge towards the center of the present invention 1. The magnets 13 remain fixed to the left piece 9 and the right piece 7 and temporarily secure those pieces opposite the second hinges 8 to generally the center of the main piece 4 as those pieces rest upon the main piece 4.

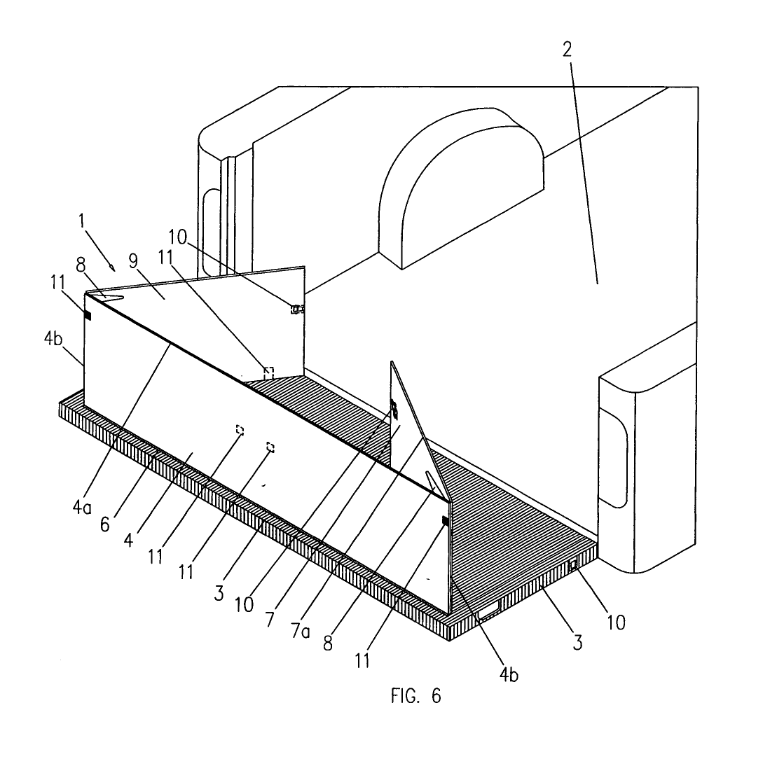

In an alternate embodiment shown in FIG. 6, an existing tailgate 3 retains its original equipment interior panel as the first hinge 6 attaches to the inside surface of the tailgate 3 upon the edge of the tailgate 3 opposite the original equipment hinges to the bed 2. The main piece 4, the left piece 9, and the right piece 7 remain the same as in the preferred embodiment and stow upon the interior panel of the tailgate 3.

In use, a driver lowers the tailgate 3 to deploy the invention 1. The driver releases the main piece 4 from the tailgate 3 by opening the clasps 11 from the bails 10 at the edges of the tailgate 3. The driver then rotates the main piece 4 upon the first hinge 6. When the main piece 4 is upright, the left piece 9 and the right piece 7 are released from the main piece 4 as the driver opens the clasps 11 from the bails 10 at the center of the main piece 4. The driver then extends the left piece 9 and the right piece 7 outwards and parallel to the sidewalls of the pickup bed 2. After fully extending the left piece 9 and the right piece 7, the driver secures the clasps 11 of the left piece 9 and the right piece 7 to the tailgate 3 at the fittings 10. The secured pieces 9, 7 along with the upright main piece 4 are then ready to receive lengthy or bulky cargo. After transporting cargo, the driver releases the clasps 11 from the bails, folds the left piece 9 and the right piece 7 under the main piece 4 and secures the left piece 9 and the right piece 7 to the clasps 11 upon the inside face of the main piece 4 using bails 10, then stows the main piece 4 into the tailgate 3, and lastly secures the main piece 4 with clasps 11 to fittings upon the edges of the tailgate 3 near the bed 2 as shown in FIGS. 2 and 3.

Alternatively, the driver releases the main piece 4 from the tailgate 3 by opening the clasps 11 from the bails 10 at the edges of the tailgate 3. The driver then rotates the main piece 4 upon the first hinge 6 so that the main piece 4 hangs downward from the tailgate 3 as shown in FIG. 5. The driver then loads cargo into the bed 2. After loading cargo, the left piece 9 and the right piece 7 are released from the main piece 4 as the driver opens the clasps 11 from the bails 10 at the center of the main piece 4. The driver then rotates the main piece 4 towards the tailgate 3 with the left piece 9 and the right piece 7 opened towards the ends of the tailgate 3. After rotating the main piece 4 upright, the driver secures the clasps 11 of the left piece 9 and the right piece 7 to the tailgate 3 at the fittings 10. The driver transports-cargo and then stows the present invention as before.

From the aforementioned description, a vehicle bed extender internally mounted has been described. The vehicle bed extender internally mounted is uniquely capable of temporarily lengthening the walls of a pickup truck bed for hauling bulky and lengthy cargos. The vehicle bed extender internally mounted and its various components may be manufactured from many materials including but not limited to steel, ferrous and non-ferrous metals, their alloys, polymers, high density polyethylene HDPE, polyvinyl chloride PVC, nylon, and composites. As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device to extend the bed of a vehicle, generally replacing the inside surface of the tailgate of the vehicle, comprising:
a main piece having a generally planar shape, two longitudinal sides and two lateral sides perpendicular to said longitudinal sides, and means to secure said main piece to the tailgate located upon said lateral sides;
one or more first hinges spaced upon one longitudinal side of said main piece and connected to the tailgate;
a right piece, having a generally planar shape of lesser length than said main piece, one or more longitudinal sides and one or more lateral sides, one or more second hinges spaced upon one lateral side and connected to said lateral side of said main piece, and means to secure said right piece to said main piece and to the tailgate upon one of said longitudinal sides opposite said second hinges proximate to the tailgate;
a left piece, having a generally planar shape of lesser length than said main piece, one or more longitudinal sides and one or more lateral sides, one or more second hinges spaced upon one lateral side and connected to said lateral side of said main piece opposite said right piece, and means to secure said left piece to the main piece and to the tailgate upon one of said longitudinal sides opposite said second hinges proximate to the tailgate; and,
a liner generally rectangular in shape and adapted to be joined within the tailgate;
whereby a driver of the vehicle lifts said main piece upright then opens said securing means and then unfolds said left piece and said right piece from said main piece, places said left piece and said right piece parallel to the bed of the vehicle, secures said left piece and said right piece to the tailgate using said securing means, and lastly loads cargo within said device.

2. The bed extending device of claim 1 further comprising:
said securing means having one or more bails and one or more cooperating clasps,
said bails are located upon edges of the tailgate proximate to the bed and said clasps are located upon said main piece, said left piece, and said right piece so that said bails grasp said clasps upon said main piece when said device is stowed within the tailgate and said bails grasp said clasps upon said left piece and said right piece when said device is deployed upon the tailgate, and
said clasps are also located upon said lateral edges of said left piece and said right piece opposite said second hinges and said bails are also located generally centered and symmetric upon said main piece so that said bails grasp said clasps when said device is stowed and then rotated out of the tailgate.

3. The bed extending device of claim 1 wherein said main piece is rectangular in shape with two mutually parallel and spaced apart longitudinal sides and two mutually parallel and spaced apart lateral sides generally perpendicular to said longitudinal sides; said right piece is rectangular in shape with two mutually parallel and spaced apart longitudinal sides and two mutually parallel and spaced apart lateral sides generally perpendicular to said longitudinal sides; and, said left piece is rectangular in shape with two mutually parallel and spaced apart longitudinal sides and-two mutually parallel and spaced apart lateral sides generally perpendicular to said longitudinal sides.

4. The bed extending device of claim 1 further comprising:
one first hinge, generally of the piano type; and,
two second hinges, on each of said left piece and said right piece.

5. The bed extending device of claim 1 wherein said device is adapted to replace the inside surface of the tailgate.

6. The bed extending device of claim 1 further comprising:
said securing means having one or more bails and one or more cooperating clasps,
wherein said bails are located upon an edge of the tailgate proximate to the bed and said clasps are located upon said main piece, said left piece, and said right piece so that said bail grasps said clasp upon said main piece when the device is stowed upon the tailgate and said bail grasps said clasps upon said left piece and said right piece when the device is deployed upon the tailgate; and
having two or more magnets upon said left piece and said right piece so that said magnets retain said left piece and said right piece as temporarily folded upon said main piece when the device is stowed and then rotated out of the tailgate.

7. A device to extend the bed of a vehicle, generally attached to the inside surface of the tailgate of the vehicle, comprising:
a main piece having a generally planar shape, two longitudinal sides and two lateral sides perpendicular to said longitudinal sides, and means to secure said main piece to the tailgate located upon said lateral sides;
one or more first hinges spaced upon one longitudinal side of said main piece and connected to the tailgate;
a right piece, having a generally planar shape of lesser length than said main piece, one or more longitudinal sides and one or more lateral sides, one or more second hinges spaced upon one lateral side and connected to said lateral side of said main piece, and means to secure said right piece to said main piece and to the tailgate upon one of said longitudinal sides opposite said second hinges proximate to the tailgate; and,
a left piece, having a generally planar shape of lesser length than said main piece, one or more longitudinal sides and one or more lateral sides, one or more second hinges spaced upon one lateral side and connected to said lateral side of said main piece opposite said right piece, and means to secure said left piece to said main piece and to the tailgate upon one of said longitudinal sides opposite said second hinges proximate to the tailgate;
whereby a driver of the vehicle lifts said main piece upright then opens said securing means and then unfolds said left piece and said right piece from said main piece, places said left piece and said right piece parallel to the bed of the vehicle, secures said left piece and said right piece to the tailgate using said securing means, and lastly loads cargo within said device.

8. The bed extending device of claim 7 further comprising:
said securing means having one or more bails and one or more cooperating clasps,
said bails are located upon edges of the tailgate proximate to the bed and said clasps are located upon said main piece, said left piece, and said right piece so that said bails grasp said clasps upon said main piece when said device is stowed within the tailgate and said bails grasp said clasps upon said left piece and said right piece when said device is deployed upon the tailgate, and,
said clasps are also located upon said lateral edges of said left piece and said right piece opposite said second hinges and said bails are also located generally centered and symmetric upon said main piece so that said bails grasp said clasps when said device is stowed and then rotated out of the tailgate.

9. The bed extending device of claim 7 wherein said main piece is rectangular in shape with two mutually parallel and spaced apart longitudinal sides and two mutually parallel and spaced apart lateral sides generally perpendicular to said longitudinal sides; said right piece is rectangular in shape with two mutually parallel and spaced apart longitudinal sides and two mutually parallel and spaced apart lateral sides generally perpendicular to said longitudinal sides; and, said left piece is rectangular in shape with two mutually parallel and spaced apart longitudinal sides and two mutually parallel and spaced apart lateral sides generally perpendicular to said longitudinal sides.

10. The bed extending device of claim 7 further comprising:
one first hinge, generally of the piano type; and,
two second hinges, on each of said left piece and said right piece.

11. The bed extending device of claim 7 further comprising:
said securing means having one or more bails and one or more cooperating clasps,
wherein said bail is located upon an edge of the tailgate proximate to the vehicle and said clasps are located upon said main piece, said left piece, and said right piece so that said bail grasps said clasp upon said main piece when said device is stowed upon the tailgate and said bails grasp said clasps upon said left piece and said right piece when the device is deployed upon the tailgate, and
having two or more magnets upon said left piece and said right piece so that said magnets retain said left piece and said right piece folded upon said main piece when said device is stowed and then rotated out of the tailgate.
